(19) United States
(12) Patent Application Publication
(10) Pub. No.: US 2014/0364538 A1
(43) Pub. Date: Dec. 11, 2014

(54) MODIFIED CELLULOSE, METHODS OF MANUFACTURE THEREOF AND ARTICLES COMPRISING THE SAME

(71) Applicant: University of Florida Research Foundation, Inc., Gainesville, FL (US)

(72) Inventors: Ronald Howard Baney, Gainesville, FL (US); Siobhan Olive Matthews, Drogheda Co. Louth (IE); Aniket Selarka, Hillsboro, OR (US)

(21) Appl. No.: 14/363,485

(22) PCT Filed: Dec. 6, 2012
(86) PCT No.: PCT/US12/68136

§ 371 Date: Jun. 6, 2014

Related U.S. Application Data
(60) Provisional application No. 61/567,897, filed on Dec. 7, 2011.

(51) Int. Cl. C08L 1/08; C08B 15/00

(52) U.S. Cl. CPC C08L 1/08; C08B 15/00
USPC 523/447; 536/56; 524/35

(57) ABSTRACT

Disclosed herein is a method for manufacturing a reduced crystallinity cellulose comprising mixing cellulose with a fluid and a proppant; partially solvating the cellulose with the fluid to form a partially solvated cellulose; mixing the partially solvated cellulose with a supercritical fluid under conditions effective to maintain the supercritical fluid in a supercritical state; where the supercritical fluid is immiscible with the fluid; and changing the pressure so that the supercritical fluid is no longer in the supercritical state.

### CROSS REFERENCE TO RELATED APPLICATIONS

This application claims the benefit of International Application PCT/US12/068,136 filed on Dec. 6, 2012 which claims the benefit of U.S. Provisional Application No. 61/567,897, filed on Dec. 7, 2011, each of which are incorporated herein by reference in their entirety.

### BACKGROUND

This disclosure relates to modified cellulose, methods of manufacture thereof and to articles comprising the same.

Environmental awareness and the consequent legislation in some countries has necessitated a demand for the manufacturing of fuels and polymers from natural sources. Petroleum bases polymers do not degrade under natural conditions and therefore contaminate landfills. It is therefore desirable to decrease the use of non-biodegradable polymers by replacing them completely or in part (via blending) with natural biopolymers such as polysaccharides or natural polypeptides. Cellulose and starch are important natural polysaccharides. Starch may be used as a substitute for non-biodegradable polymers. However, it is mechanically weak and is easily soluble in water thus limiting its use in many applications.

Using cellulose as an alternative has distinct advantages such as mechanical properties and insolubility in water. The use of cellulose would greatly improve the applications for biopolymers in everyday consumer goods such as plastic water bottles. It is therefore desirable to increase the use of cellulose to the point that their increased use results in a decreased use of petroleum based polymers.

Cellulose unfortunately is highly crystalline, which makes it difficult to blend with other commercially available petroleum based polymers. The high crystallinity of microcrystalline cellulose comes from the glycosidic bond linkages and the intermolecular and intramolecular hydrogen bond network formed between the cellulose chains in the crystallites. The high percentage of crystallinity in cellulose reduces the possibility of blending it with other petroleum based polymers to manufacture a given product.

It is therefore desirable to reduce the crystallinity of cellulose in order to blend it with other petroleum based polymers and to reduce the weight percentage of petroleum based polymers in manufactured products.

### SUMMARY

Disclosed herein is a method for manufacturing a reduced crystallinity cellulose comprising mixing cellulose with a fluid; wherein the fluid comprises a proppant that facilitates the solvation of the cellulose by the fluid; partially solvating the cellulose with the fluid to form a partially solvated cellulose; mixing the partially solvated cellulose with a supercritical fluid under conditions effective to maintain the supercritical fluid in a supercritical state; where the supercritical fluid is immiscible with the fluid; and changing the pressure so that the supercritical fluid is no longer in the supercritical state.

Disclosed herein too is a method for manufacturing a reduced crystallinity cellulose comprising mixing the cellulose with a proppant and with a fluid; the proppant facilitating the solvation of the cellulose by the fluid; partially solvating the cellulose with the fluid to form a partially solvated cellulose; mixing the partially solvated cellulose with a supercritical fluid under conditions effective to maintain the supercritical fluid in a supercritical state; where the supercritical fluid is immiscible with the fluid; mixing the partially solvated cellulose and the supercritical fluid with a polymer; changing the pressure so that the supercritical fluid is no longer in the supercritical state; and producing a reduced crystallinity cellulose.

Disclosed herein too is a composition comprising a compatible blend of a reduced crystallinity cellulose and a polymer; where the reduced crystallinity cellulose has crystallinity in an amount of about 10 to about 90 weight percent based on a total amount of cellulose.

### BRIEF DESCRIPTION OF THE FIGURES

FIG. 1 is a bar graph of relatively crystallinity in cellulose samples processed in DMSO and supercritical CO₂ at processing pressures 2500 psi (D2500), 3500 psi (D3500) and 4500 psi (D4500);

FIG. 2 is a bar graph showing relative crystallinity (%) of cellulose samples processed in DMSO-urea-supercritical CO₂ at 2500 psi. Amount of urea in cellulose was varied as 0.25 g (UD25025), 0.50 g (UD25050), 0.75 g (UD25075), and 1.00 g (UD25010); and

FIG. 3 is a bar graph showing relative crystallinity (%) of cellulose samples processed in DMSO-urea-supercritical CO2 at 4500 psi. Amount of urea in cellulose was varied as 0.25 g (UD45025), 0.50 g (UD45050), 0.75 g (UD45075) and 1.00 g (UD45010).

### DETAILED DESCRIPTION

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The endpoints of all ranges directed to the same component or property are inclusive of the endpoint and independently combinable. The term “comprising” is inclusive of the transition terms “consisting of” and “consisting essentially of”.

Unless otherwise defined, all terms (including technical and scientific terms) used herein have the same meaning as commonly understood by one of ordinary skill in the art to which this invention belongs.

The compounds made by the above-described methods have, in embodiments, one or more isomers. Where an isomer can exist, it should be understood that the invention embodies methods that form any isomer thereof, including any stereoisomer, any conformational isomer, and any cis, trans isomer; isolated isomers thereof; and mixtures thereof.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. Alkyl groups may be straight-chained or branched. Throughout the specification, reference is made to various bivalent groups. Such groups are the same as the monovalent groups that are similarly named, and are typically indicated with an “ene” suffix. For example, a C1 to C6 alkylene group is a bivalent linking group having the same structure as a C1 to C6 alkyl group.

All cited patents, patent applications, and other references are incorporated herein by reference in their entirety.

Disclosed herein is a cellulose polymer having reduced crystallinity that can be blended with other commercially available petroleum based polymers to form compatible or partially compatible blends. The production of the reduced crystallinity polymer is useful in that it reduces the amount of petroleum based polymers that are used to manufacture a given commercial product. In one embodiment, the cellulose polymer having reduced crystallinity can be blended with a polyolefin to produce a partially compatible blend. In an exemplary embodiment, the polyolefin is low density polyethylene. Another advantage of using the cellulose polymer having reduced crystallinity is that it can be used as a replacement (both partial or complete replacement) for other naturally occurring biopolymers (such as starch) that are already used in commercially available products.

Disclosed herein too is a method for reducing crystallinity in cellulose polymers to produce a cellulose polymer having reduced crystallinity. The method comprises mixing a crystalline cellulose polymer with a solvent mixture under high shear. In one embodiment, the solvent mixture comprises a molecular proppant (hereinafter “proppant”) that enhances the solubility of the crystalline cellulose with the solvent mixture. The mixing under high shear in the presence of the molecular proppant reduces the crystallinity of the cellulose. The solvent mixture comprises a first fluid that is a supercritical fluid and a second fluid that is either partially or completely incompatible with the first fluid. The second fluid is a solvent that can partially dissolve the cellulose. The molecular proppant facilitates the solubility of the cellulose in the second fluid to dissolve the cellulose.

In one embodiment, the method comprises contacting the cellulose with the first fluid under shear. The second fluid then contacts the mixture of the cellulose and the first fluid, while also under shear. The addition of the first and the second fluids can be reversed. In other words, the second fluid can contact the cellulose prior to the addition of the first fluid to the mixture of the second fluid and the cellulose. The proppant is added either to the mixture of the cellulose with the first fluid and the second fluid or to the mixture of the cellulose with either the first fluid or the second fluid.

In an exemplary embodiment, the first fluid is supercritical carbon dioxide while the second fluid is one that can either partially solvate the cellulose to form the partially solvated cellulose. An exemplary first fluid is supercritical carbon dioxide while an exemplary second fluid is dimethyl sulfoxide (DMSO).

In one embodiment, the second fluid contacts the cellulose to form a partially solvated cellulose. The proppant is added either to the partially solvated cellulose or to the second fluid prior to the solvation of the cellulose. Without being limited by theory, the proppant is a molecule that increases the solvation of the cellulose by the second solvent. The proppant physically opens up the material to be solvated so as to increase the solubility of the solvent in the material. In this particular case, the proppant may facilitate a better dispersion of the second fluid in the cellulose and may also facilitate a reduction of the crystallinity in the cellulose. These molecular proppants must have the following properties: 1. low enough vapor pressure to remain behind in the cellulose after removal of the supercritical carbon dioxide, 2. form stronger hydrogen-bonding complexes with the cellulose COH structures than are formed by their intra and inter molecular hydrogen-bond structures, and 3. be compatible with the second fluid (e.g., DMSO). The list of molecular proppants provided below was selected with these properties in mind. All of the hydrogen-bond sites in the cellulose need not be blocked by the proppant.

The first fluid generally does not solvate the cellulose, but is permitted to contact a partially or completely solvated cellulose under pressure. The application of pressure (from retaining the first fluid in its supercritical state when it contacts the mixture) to the partially solvated cellulose facilitates the disruption of bonds that permit the crystallization of cellulose, thus reducing the crystallinity of the cellulose.

As noted above, the second fluid is one that can partially solvate the cellulose. Examples of solvents that can partially solvate the cellulose are non-derivatizing and/or derivatizing solvents. The term “non-derivatizing” applies to solvents that can dissolve the polymer by intermolecular interactions only. These solvents have a very strong interaction with the cellulose but are classified as solvents because no covalent interactions occur with the cellulose. Examples of non-derivatizing solvents are aqueous transition metal complex solvents. Examples of aqueous transition metal complex solvents are transition metal complexes with amines, ammonium hydroxides, alkali hydroxides, or the like, or a combination comprising at least one of the foregoing aqueous transition metal complex solvents.

Examples of non-derivatizing solvents are Cadoxen—[Cd(H₂N—(CH₂)₂—NH₂)₃](OH)₂, Cdtren—[Cd(NH₂−CH₂—CH₂)₃N](OH)₂, Cooxen—[Co(H₂N—(CH₂)₂—NH₂)₂](OH)₂, Cupren—[Cu(H₂N—(CH₂)₃NH₂)₂](OH)₂, Cuam—[Cu(NH₃)₄](OH)₂, Cuen—[Cu(H₂N—(CH₂)₂—NH₂)₂](OH)₂, Nioxam—[Ni(NH₃)₆](OH)₂, Nioxen—[Ni(H₂N—(CH₂)₂—NH₂)₃](OH)₂, Nitren—[Ni(NH₂ CH₂ CH₂)₃ N](OH)₂, Pden—[Pd(H₂N—(CH₂)₂—NH₂](OH)₂, Zincoxen—[Zn(H₂N—(CH₂)₂—NH₂)₂](OH)₂, Na₆[Fe(C₄H₃O₆)₃], trimethylbenzyl ammonium hydroxide, tetraethylammonium hydroxide, dimethyldibenzyl ammonium hydroxide, guanidinium hydroxide, sodium hydroxide, lithium hydroxide, and a combination comprising at least one of the foregoing non-derivatizing solvents.

Non-aqueous, non-derivatizing solvents can also be used. Non-aqueous solvents can be single component or multicomponent solvents. Examples of single component non-aqueous solvents are n-alkylpyridinium halides such as n-ethylpyridinium chloride, n-oxides of tertiary amines such as n-methylmorpholine-N-oxide and alkylsulfoxides such as dimethyl sulfoxide. Examples of non-aqueous, non-derivatizing solvents are multi-component blends comprising polar organic liquid/SO₂/primary, secondary or tertiary aliphatic or secondary alicyclic amine. An exemplary multicomponent blend is a mixture comprising dimethyl sulfoxide (DMSO)/SO/diethylamine.

The group of “derivatizing” solvents comprises all the systems where dissolution occurs in combination with formation of “unstable” ether, ester, or acetal derivatives. A specification within the large group of solvents acting via the formation of covalent derivatization of the polymer is given by the criterion that the derivative formed in a so-called derivatizing solvent is easily decomposed to regenerate cellulose by changing the medium (e.g., non-aqueous to aqueous) or the pH-value of the medium. Both categories of solvents comprise aqueous and non-aqueous media.

The volume percent of the second fluid in the supercritical carbon dioxide is about 1.0 to about 10 percent, based on the total weight of the solvent mixture. In a preferred embodiment, the weight percent of the supercritical carbon dioxide in the solvent mixture is about 1.5 to about 8 volume percent, based on the total weight of the solvent mixture.

The weight percent of the proppant in the solvent mixture is about 1.0 to about 27.0 weight percent, based on the total weight of the solvent mixture. In a preferred embodiment, the weight percent of the proppant in the solvent mixture is about 4.0 to about 16.0 weight percent, based on the total weight of the solvent mixture.

The ratio of the cellulose to the solvent mixture is about 15 to about 25 weight percent, based on the total weight of the solvent mixture and the cellulose. In a preferred embodiment, the ratio of the cellulose to the solvent mixture is about 19 to about 21 weight percent, based on the total weight of the solvent mixture and the cellulose.

An exemplary second fluid is a single component, non-derivatizing solvent. Dimethylsulfoxide is preferred as the second solvent, while supercritical carbon dioxide is the preferred first solvent.

An exemplary second fluid is a single component, non-derivatizing solvent. dimethylsulfoxide is preferred as the second solvent, while supercritical carbon dioxide is the preferred first solvent.

In one embodiment, in one method of reducing the crystallinity in microcrystalline cellulose, the cellulose is first contacted with dimethylsulfoxide. The cellulose is first swollen by the dimethylsulfoxide to form the partially solvated cellulose. The partially solvated cellulose is then contacted with supercritical carbon dioxide. Carbon dioxide becomes supercritical at it temperatures greater than the critical temperature (31.1° C.) and pressures greater than the critical pressure (72.9 atm/7.39 MPa). At temperatures and pressures greater than the critical point, carbon dioxide expands like a gas but has a density similar to that of a liquid. Without being limited to theory, it is generally believed that the pressure of the supercritical carbon dioxide helps the solvent molecules to penetrate more deeply into the cellulose crystalline structure, causing a disruption of the hydrogen bonds and leading to a reduction in the amount of crystallinity. In other words, the high mass transfer rate of carbon dioxide in the supercritical state facilitates the diffusion of solvent molecules into the crystalline structure of the cellulose. The pressure during solvation can be increased to 500 pounds per square inch (psi) to 6,000 psi, specifically 1,000 to 5,000 psi, 1,500 psi to 4,500 psi.

As noted above, a greater degree of solvation of the cellulose is achieved by adding the proppant to the second fluid prior to the solvation of the cellulose. The proppant can be added either to the first fluid, the second fluid or the mixture of fluids prior to contacting the cellulose with the respective fluids. In one embodiment, the proppant can be dispersed in the cellulose prior to contacting the cellulose with the first fluid, the second fluid or the mixture of the first fluid and the second fluid.

The proppant is generally soluble in at least one of the fluids that contact the cellulose. In one embodiment, the proppant may be soluble in either the first fluid or the second fluid, but not in both the first fluid and the second fluid. In another embodiment, the proppant may be soluble in the first fluid, but not in the second fluid. In another embodiment, the proppant may be soluble in the second fluid, but not in the first fluid. In yet another embodiment, the proppant may be soluble in both the first fluid and the second fluid.

The proppant may be retained in the cellulose after the crystalline content in the cellulose is reduced. In one embodiment, the proppant may be extracted from the cellulose after the crystalline content in the cellulose is reduced. In another embodiment, a portion of the cellulose may be extracted from the cellulose after the crystalline content of the cellulose is reduced. In one embodiment, the proppant (e.g., such as residual urea) may be used to compatibilize the reduced crystalline content cellulose with another otherwise incompatible polymer (where the polymer is normally incompatible with the cellulose).

In another embodiment, the solvation of the cellulose may be increased by adding the proppant to the solvent mixture (i.e., to the mixture of the first fluid and the second fluid prior to the solvation of the cellulose). In yet another embodiment, the proppant may be added to the cellulose prior to contacting the cellulose with the first fluid or the second solvent.

Examples of the proppant are urea, polysaccharides, chitosan, chitin, starch, and the like. In an exemplary embodiment, urea is used as the proppant when the first fluid is supercritical carbon dioxide and when the second fluid is DMSO.

In an exemplary embodiment, the proppant is soluble in the DMSO, but is not soluble in the supercritical carbon dioxide. When urea is the proppant and DMSO is the carrier, the DMSO acts as a carrier for the urea into the cellulose. Without being limited by theory, the supercritical carbon dioxide can assist with facilitating the diffusing the urea into the bulk of the cellulose. In other words, the supercritical carbon dioxide facilitates a better dispersion of the proppant into the cellulose. The introduction of the urea into the cellulose facilitates a greater reduction in cellulose crystallinity. Urea can also interact with the cellulose by forming cellulose carbamate or can be entrapped physically by the hydrogen bonds in the cellulose structure.

The molecular proppant is added in an amount of about 3 to about 70, specifically about 10 to about 69, and more specifically about 15 to about 67 weight percent based on the total weight of the cellulose. In a preferred embodiment, the molecular proppant is added in an amount of about 16 to about 60 weight percent based on the total weight of the cellulose.

The mixing of the cellulose with the first fluid and the second fluid and with the proppants can be conducted in a static mixer or in a dynamic mixer. Combinations of static mixers and dynamic mixers may also be used. A static mixer is a device for mixing two fluid materials. Most commonly, the fluids are liquid; however, static mixers are used to mix gas streams, disperse gas into liquid or disperse immiscible liquids. The device consists of mixer elements contained in a cylindrical (tube) or squared housing. The static mixer is generally operated at a pressure and temperature that is effective to retain the carbon dioxide in its supercritical state.

In another embodiment, the mixing of the partially solvated cellulose with the supercritical carbon dioxide can be conducted in a dynamic mixer. Dynamic mixing of the partially solvated cellulose involves the use of shear force, extensional force, compressive force, ultrasonic energy, electromagnetic energy, thermal energy or combinations comprising at least one of the foregoing forces or forms of energy and is conducted in processing equipment wherein the aforementioned forces or forms of energy are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations comprising at least one of the foregoing.

Dynamic mixing involving the aforementioned forces may be conducted in machines such as single or multiple screw extruders, Buss kneader, Henschel, helicones, Ross mixer, Banbury, roll mills, molding machines such as injection molding machines, vacuum forming machines, blow molding machine, or the like, or combinations comprising at least one of the foregoing machines. As noted above, the mixers are generally operated at a pressure and temperature that is effective to retain the carbon dioxide in its supercritical state.

An exemplary device for conducting the mixing is a twin screw extruder.

Upon release from the static mixer or the dynamic mixer the supercritical carbon dioxide evaporates and facilitates the evaporation of the second fluid as well. Any further traces of the second fluid may be removed by exposure to the atmosphere. The cellulose that is removed from the mixer is a reduced crystallinity cellulose.

In one embodiment, the crystallinity of the cellulose is reduced from about 75 weight percent to about 40 weight percent upon being removed from the static or dynamic mixer.

In one embodiment, in one manner of proceeding to reduce the crystallinity of the cellulose, the cellulose along with the proppant is first blending with a mixture of the first fluid and the second fluid. The cellulose upon being blended with the first fluid and the second fluid is swollen because of its solubility in at least one of the fluids. The solvation of the cellulose with the first and the second fluids is conducted at an increased temperature and pressure. In an exemplary embodiment, the cellulose is at least partially soluble in the second fluid. During the solvation of the cellulose under pressure and temperature, it is believed that the crystallinity of the cellulose is reduced. Following the partial solvation and the reduction in crystallinity of the cellulose, the solvents are removed from the solvated cellulose. The removal of the solvents leaves behind a reduced crystallinity cellulose which can then be blended with other polymers or materials in a device such as an extruder.

In one embodiment, the solvents are not completely extracted from the reduced crystallinity cellulose. The retention of a small amount of the solvent and proppant in the reduced crystallinity cellulose can be used to facilitate blending with other polymers.

In one embodiment, in another method of proceeding to reduce the crystallinity of the cellulose, the cellulose may be contacted with either the first solvent or the second solvent. Following the contact with either the first solvent or the second solvent, the cellulose is then contacted with the other solvent. The proppant may be present in either the fluid that is used to contact the cellulose first or second. Alternatively, the proppant may be first dispersed in the cellulose prior to contacting the cellulose with the first fluid or the second fluid.

In yet another embodiment, the proppant may be added to the cellulose after the first fluid and/or the second fluid have contacted the cellulose. The cellulose may first be contacted with the first and/or second fluid to partially solvate the cellulose. Following this, the proppant may be added to the partially solvated cellulose followed by agitation in devices such as extruders, and the like, to further solvate the cellulose. The first fluid and the second fluid may then be removed from the cellulose to leave a reduced crystallinity cellulose.

In one embodiment, the reduced crystallinity cellulose can be further blended with a polymer. The blending of the reduced crystallinity cellulose can be conducted simultaneously with the solvation of the partially solvated cellulose with the supercritical carbon dioxide or alternatively it can be conducted after the solvents are removed from the cellulose. The reduced crystallinity of the cellulose permits it to form compatible blends with polymers that it could not otherwise be blended with.

Polymers that can be blended with the reduced crystallinity cellulose are thermoplastic polymers, thermosetting polymers, blends of thermoplastic polymers, blends of thermosetting polymers, and blends of thermoplastic polymers with thermosetting polymers. The polymer can be a homopolymer, a copolymer, a block copolymer, an alternating copolymer, an alternating block copolymer, a random copolymer, a random block copolymer, a graft copolymer, a star block copolymer, an ionomer, a dendrimer, or a combination comprising at least one of the foregoing polymers. An exemplary polymer for blending with the reduced crystallinity cellulose is a thermoplastic polymer. The polymer may be semi-crystalline of amorphous.

Examples of thermoplastic polymers are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, ethylene propylene diene rubber (EPR), polytetrafluoroethylene, fluorinated ethylene propylene, perfluoroalkoxyethylene, polychlorotrifluoroethylene, polyvinylidene fluoride, polysiloxanes, or the like, or a combination comprising at least one of the foregoing organic polymers.

Examples of thermosetting polymers suitable for blending with the reduced crystallinity cellulose include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination comprising at least one of the foregoing thermosetting polymers.

The reduced crystallinity may be advantageously used as a replacement for naturally occurring biopolymers in currently available commercially existing systems. Other biopolymers (both naturally occurring and synthetic) that can be replaced with the reduced crystallinity cellulose are starch, polylactic acid, polylactic-glycolic acid (PLGA), poly-caprolactone (PCL), copolymers of polylactic-glycolic acid and poly-caprolactone (PCL-PLGA copolymer), polyhydroxy-butyrate-valerate (PHBV), polyorthoester (POE), polyethylene oxide-butylene terephthalate (PEO-PBTP), poly-D,L-lactic acid-p-dioxanone-polyethylene glycol block copolymer (PLA-DX-PEG), or the like, or combinations comprising at least one of the foregoing biopolymers. In an exemplary embodiment, the reduced crystallinity cellulose may be used to replace starch.

An exemplary polymer that can be blended with the reduced crystallinity cellulose is a polyolefin. Examples of polyolefins are low density polyethylene, high density polyethylene, linear low density polyethylene, or the like, or a combination comprising at least one of the foregoing polyolefins. An exemplary polyethylene for blending with the reduced crystallinity cellulose is low density polyethylene.

A blend comprising reduced crystallinity cellulose and another polymer (e.g., the polyethylene) generally comprises the reduced crystallinity cellulose in an amount of about 5 to about 85 weight percent based upon the total weight of the blend. A blend comprising reduced crystallinity cellulose and another polymer generally comprises the reduced crystallinity cellulose in a preferred amount of about 5 to about 70 weight percent based upon the total weight of the blend.

A blend comprising reduced crystallinity cellulose and another polymer generally comprises the other polymer in an amount of about 10 to about 90 weight percent based upon the total weight of the blend.

The blend comprising the reduced crystallinity cellulose can be used in a variety of commercial applications. Examples of such applications included trash bags, automotive exterior body panels, panels for electronics (computers, television sets, semiconductor trays), and the like.

In one embodiment, the reduced crystallinity cellulose may be used as a binder for metals, ceramics and other polymers. Examples of metals are copper, nickel, stainless steel, iron, tin, brass, and the like. Examples of ceramics are metal oxides, metal nitrides, metal carbides, metal borides, metal silicides, and the like. Examples of ceramics are silicon dioxide, aluminum oxide, titanium oxide, zirconium oxide, indium oxide, indium tin oxide, and the like.

The aforementioned method and composition are exemplified by the following non-limiting example.

### Example

Batch Processing of cellulose with DMSO-Supercritical CO₂ and DMSO-Urea-Supercritical CO₂.

Microcrystalline cellulose is first be swollen using DMSO and then pressurized under supercritical CO₂ to improve effectiveness of DMSO towards altering the microstructure. The pressurizing is conducted in a supercritical reactor. Application of supercritical CO₂ helps the DMSO molecules penetrate deeper into crystalline structure, cause disruption of hydrogen bonds, and finally lead to a reduction in crystallinity.

The high mass-transfer rate in the supercritical state can assist the diffusion of the DMSO molecules into the cellulose. DMSO is extracted from cellulose by conducting a supercritical CO₂ drying run, which involves depressurizing CO₂ over a fixed pressure range. Microcrystalline cellulose does not dissolve in DMSO but only undergoes swelling.

Urea is used as the proppant and is easily soluble in DMSO but poorly soluble in supercritical CO₂. The urea was introduced in amounts of 0.25 grams, 0.5 grams 0.75 grams and 1.0 grams as is described in detail below.

For each batch reaction, 1.5 g microcrystalline cellulose was added into 5 ml DMSO and the mixture was stirred at 80 rpm at 30° C. for 2 minutes inside a fume hood. The white heterogeneous solution, as formed, was immediately transferred into a supercritical reactor before it turned into a gel. For batch reactions with urea, known quantity of urea was first added into 5 ml DMSO, stirred at 80 rpm at 30° C. until a clear homogeneous solution was formed. Cellulose was added subsequently. The reactor with a viewing glass was held horizontally using a stir-plate support and purged with CO₂ between 50 to 80 psi for about 1 minute. The reactor was heated to 80° C. During the heating process, the outlet port of the reactor was closed and it was filled with CO₂ (about 850 psi) when the temperature reached to about 40° C. The inlet port of the reactor was closed and CO₂ was pressurized to the desired pressure values (2500 psi or 4500 psi) by syringe pump. Once the temperature reached the desired value, the inlet port of the reactor was opened and pressurized CO₂ was transferred into it at gas flow rate of 80 ml/min. The inlet valve of the reactor was closed when syringe pump and reactor reached the desired pressure equilibrium. The solution was kept inside view reactor under this temperature and pressure condition for 30 minutes. The solution was stirred at about 500 rpm using a stirring bar inside the reactor. The stirring speed was controlled by the stir-plate. After 30 minutes of reaction time, DMSO was removed along with CO₂ by depressurizing CO₂. Depressurization process was conducted in multiple steps of 2500 psi to 2000 psi. If the batch reaction was conducted at CO₂ pressures higher than 2500 psi, then the depressurization process included first a step down from maximum pressure to 2500 psi and 2500 psi to 2000 psi in subsequent multiple pressure steps.

Depressurization was stopped when sample under reactor was observed as a free flowing powder. The pressure and temperature were brought down to room conditions. The sample was removed from reactor and transferred in a vacuum sealable container. It is worth noting that the batch reactions involving both microcrystalline cellulose and urea required longer depressurization times to obtain dry powder samples compared to reactions in absence of urea. Compositions and processing conditions used are listed in Tables 1 and Table 2.

TABLE 1

| | | | Temperature | Carbon dioxide |
|---|---|---|---|---|
| Sample | Cellulose (g) | DMSO (ml) | (° C.) | pressure (psi) |
| Unmodified | 1.5 | N/A | N/A | N/A |
| Cellulose | | | | |
| D2500* | 1.5 | 5 | 80 | 2500 |
| D3500* | 1.5 | 5 | 80 | 3500 |
| D4500* | 1.5 | 5 | 80 | 4500 |

*The letter D denotes DMSO and the succeeding number denotes the carbon dioxide pressure that the cellulose was processed at.

TABLE 2

| | | | | | Carbon |
|---|---|---|---|---|---|
| | | | | | dioxide |
| | | | Urea | Temperature | pressure |
| Sample | Cellulose (g) | DMSO (ml) | (g) | (° C.) | (psi) |
| **UD25025 | 1.5 | 5 | 0.25 | 80 | 2500 |
| **UD25050 | 1.5 | 5 | 0.50 | 80 | 2500 |
| **UD25075 | 1.5 | 5 | 0.75 | 80 | 2500 |
| **UD25010 | 1.5 | 5 | 1.0 | 80 | 2500 |
| **UD45025 | 1.5 | 5 | 0.25 | 80 | 4500 |
| **UD45050 | 1.5 | 5 | 0.50 | 80 | 4500 |
| **UD45075 | 1.5 | 5 | 0.75 | 80 | 4500 |
| **UD45010 | 1.5 | 5 | 1.0 | 80 | 4500 |

**The letter UD denotes DMSO-Urea mixture. The first two digits of the numeric figure denote the CO₂ pressure (psi) at which cellulose was processed (e.g. 25 for 2500 psi and 45 for 4500 psi). The last three digits correspond to the urea content (g) (025 for 0.25 g, 050 for 0.50 g, 075 for 0.75 g and 010 for 1.00 g).

As seen in the Table 1, the reactor was pressurized to 2500 pounds per square inch (psi), 3500 psi and 4500 psi respectively in separate runs. DMSO acts as a carrier for urea molecules in the crystalline structure of cellulose. Supercritical CO₂ can assist in diffusing urea deeper into the structure. The poor solubility of urea with supercritical CO₂ can be used to extract only DMSO during the supercritical drying run. This introduction of urea results in a further reduction in cellulose crystallinity. Urea can either interact chemically with cellulose by forming cellulose carbamate or it can physically be entrapped by hydrogen bonds in the cellulose structure. Either way it will increase the free volume of cellulose and so contribute to reducing crystallinity. Table 3 shows selective interactions among the components.

TABLE 3

| | | | | | Urea- |
|---|---|---|---|---|---|
| | | Cellulose- | DMSO- | | Super- |
| | Cellulose- | supercritical | supercritical | DMSO- | critical |
| Composition | DMSO | CO₂ | CO₂ | Urea | CO₂ |
| Miscibility | Partial | Poor | Good | Good | Poor |
| of | | | | | |
| components | | | | | |

The percentage crystallinity of the resulting compositions was studied using Wide Angle X-Ray Diffraction (WXRD). The relative crystallinity was calculated by following formula:

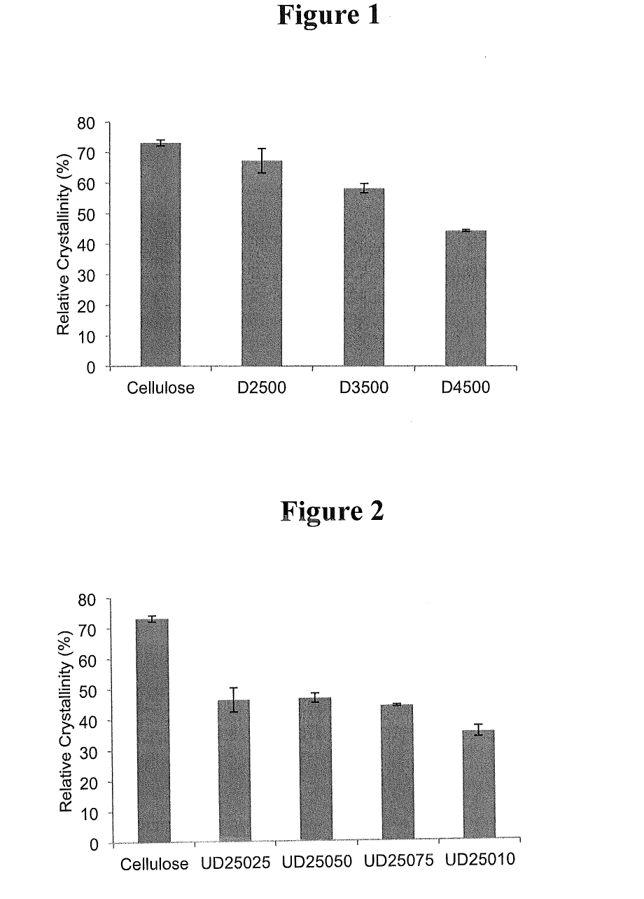

Relative Crystallinity (%)=Ac÷(Aa+Ac)×100,

where Ac is the sum of integral area of peaks assigned to crystalline regions (110), (110), (102), (200) and Aa is the integral area of amorphous region of the spectrum with maximum intensity at 2-theta value of 22.5°. From a quantitative comparison, it was determined that the relative degree of crystallinity of samples followed a decreasing trend with increase in processing pressure. The results are shown in the FIG. 1.

Cellulose processed with DMSO at 2500 psi (D2500) was only marginally affected but relative crystallinity of cellulose processed with DMSO at 4500 psi (D4500) was reduced by about 40% from that of unmodified cellulose. From these results, it can be seen that the increase in processing pressures of supercritical CO₂ resulted in deeper penetration of DMSO into microfibrils of cellulose without affecting the original crystal structure. The change in relative crystallinity in spite of unmodified crystal structure suggests that the DMSO molecules affected the cellulose by interacting with intermolecular bonds in the amorphous region of cellulose.

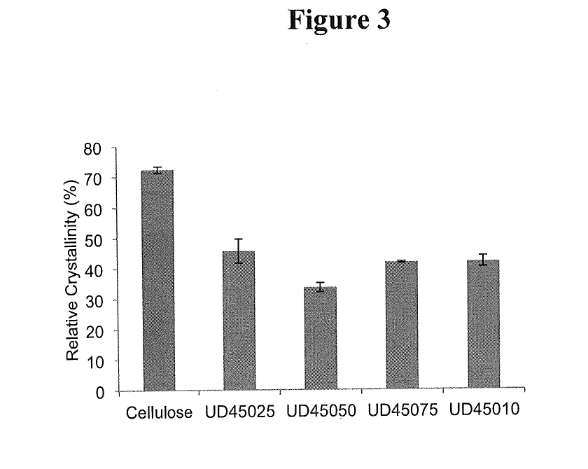

Quantitative comparison of the relative crystallinity of urea containing cellulose samples are also shown in the FIG. 2. The samples processed at 2500 psi followed a marginal decreasing trend while the least degree of crystallinity (32%) was calculated for the UD25010 sample. Samples processed at 4500 psi (See FIG. 3) did not show any significant reduction in the relative crystallinity with increasing urea content. However, the relative crystallinity of the cellulose samples processed at this pressure showed about 45% reduction in crystallinity from that of unmodified cellulose.

From these results, it may be seen that the use of dimethylsulfoxide, supercritical carbon dioxide and urea can reduce the percentage crystallinity in microcrystalline cellulose up to 60 wt %, specifically by up to 50 wt %, specifically by up to 40 wt %, and more specifically by up to 20 wt %, especially when compared with samples that are not subjected to the dimethylsulfoxide, supercritical carbon dioxide and urea.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method for manufacturing a reduced crystallinity cellulose comprising:
mixing cellulose with a fluid; wherein the fluid comprises a proppant that facilitates the solvation of the cellulose by the fluid;
partially solvating the cellulose with the fluid to form a partially solvated cellulose;
mixing the partially solvated cellulose with a supercritical fluid under conditions effective to maintain the supercritical fluid in a supercritical state; where the supercritical fluid is immiscible with the fluid; and
changing the pressure so that the supercritical fluid is no longer in the supercritical state.

2. The method of claim 1, further comprising mixing the reduced crystallinity cellulose with a polymer to form a compatible blend.

3. The method of claim 2, where the reduced crystallinity cellulose is present in an amount of about 5 to about 85 weight percent, based on a total weight of the compatible blend.

4. The method of claim 2, where the polymer is a thermoplastic polymer.

5. The method of claim 2, where the proppant is urea, polysaccharide, chitosan, chitin, starch, or a combination thereof.

6. The method of claim 2, where the polymer is a crystalline polymer.

7. The method of claim 2, where the polymer is an amorphous polymer.

8. The method of claim 2, where the polymer is a homopolymer, a copolymer, a block copolymer, an alternating copolymer, an alternating block copolymer, a random copolymer, a random block copolymer, a graft copolymer, a star block copolymer, an ionomer, a dendrimer, or a combination comprising at least one of the foregoing polymers.

9. The method of claim 2, where the polymer is a thermoplastic polymer selected from the group consisting of polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, styrene acrylonitrile, acrylonitrile-butadiene-styrene, polyethylene terephthalate, polybutylene terephthalate, polyurethane, ethylene propylene diene rubber, polytetrafluoroethylene, fluorinated ethylene propylene, perfluoroalkoxyethylene, polychlorotrifluoroethylene, polyvinylidene fluoride, polysiloxanes, starch, polylactic-glycolic acid, poly-caprolactone, copolymers of polylactic-glycolic acid and poly-caprolactone, polyhydroxy-butyrate-valerate, polyorthoester, polyethylene oxide-butylene terephthalate, poly-D,L-lactic acid-p-dioxanone-polyethylene glycol block copolymer, or a combination comprising at least one of the foregoing organic polymers.

10. The method of claim 2, where the polymer is a thermosetting polymer selected from the group consisting of epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or a combination comprising at least one of the foregoing thermosetting polymers.

11. The method of claim 9, where the polyolefin is linear low density polyethylene, low density polyethylene, or high density polyethylene.

12. The method of claim 9, where the polyolefin is low density polyethylene.

13. The method of claim 1, where the fluid is selected from the group consisting of [Cd(H₂N—(CH₂)₂—NH₂)₃](OH)₂, [Cd(NH₂—CH₂—CH₂)₃ N](OH)₂, [Co(H₂N—(CH₂)₂—NH₂)₂](OH)₂, [Cu(H₂N—(CH₂)₃—NH₂)₂](OH)₂, [Cu(NH₃)₄](OH)₂, [Cu(H₂N—(CH₂)₂—NH₂)₂](OH)₂, [Ni(NH₃)₆](OH)₂, [Ni(H₂N—(CH₂)₂—NH₂)₃](OH)₂, [Ni(NH₂ CH₂CH₂)₃N](OH)₂, Pden—[Pd(H₂N—(CH₂)₂—NH₂](OH)₂, [Zn(H₂N—(CH₂)₂—NH₂)₂](OH)₂, Na₆[Fe(C₄H₃O₆)₃], trimethylbenzyl ammonium hydroxide, tetraethylammonium hydroxide, dimethyldibenzyl ammonium hydroxide, guanidinium hydroxide, sodium hydroxide, lithium hydroxide, or a combination comprising at least one of the foregoing non-derivatizing solvents.

14. The method of claim 1, where the fluid is selected from the group consisting of
n-alkylpyridinium halides, n-oxides of tertiary amines and alkylsulfoxides.

15. The method of claim 1, where the fluid is dimethylsulfoxide.

16. The method of claim 1, where the mixing is conducted in a twin screw extruder.

17. The method of claim 1, where the mixing is conducted in a single or multiple screw extruder, Buss kneader, Henschel, helicones, Ross mixer, Banbury, roll mills, molding machines, injection molding machines, vacuum forming machines, blow molding machine, or combinations comprising at least one of the foregoing machines.

18. A method for manufacturing a reduced crystallinity cellulose comprising:
mixing the cellulose with a proppant and with a fluid; the proppant facilitating the solvation of the cellulose by the fluid;
partially solvating the cellulose with the fluid to form a partially solvated cellulose;
mixing the partially solvated cellulose with a supercritical fluid under conditions effective to maintain the supercritical fluid in a supercritical state; where the supercritical fluid is immiscible with the fluid;
mixing the partially solvated cellulose and the supercritical fluid with a polymer;
changing the pressure so that the supercritical fluid is no longer in the supercritical state; and
producing a reduced crystallinity cellulose.

19. The method of claim 18, further comprising mixing the reduced crystallinity cellulose with a polymer to form a compatible blend.

20. The method of claim 19, where the reduced crystallinity cellulose is present in an amount of about 30 to about 50 weight percent, based on a total weight of the compatible blend.

21. The method of claim 19, where the proppant is a molecular proppant.

22. The method of claim 21, where the molecular proppant is a urea, chitosan, chitin, a polysaccharide, starch or a combination thereof.

23. The method of claim 19, where the polymer is a crystalline polymer.

24. The method of claim 19, where the polymer is an amorphous polymer.

25. The method of claim 19, where the polymer is a homopolymer, a copolymer, a block copolymer, an alternating copolymer, an alternating block copolymer, a random copolymer, a random block copolymer, a graft copolymer, a star block copolymer, an ionomer, a dendrimer, or a combination comprising at least one of the foregoing polymers.

26. The method of claim 19, where the polymer is a thermoplastic polymer selected from the group consisting of polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, styrene acrylonitrile, acrylonitrile-butadiene-styrene, polyethylene terephthalate, polybutylene terephthalate, polyurethane, ethylene propylene diene rubber, polytetrafluoroethylene, fluorinated ethylene propylene, perfluoroalkoxyethylene, polychlorotrifluoroethylene, polyvinylidene fluoride, polysiloxanes, starch, polylactic-glycolic acid, poly-caprolactone, copolymers of polylactic-glycolic acid and poly-caprolactone, polyhydroxy-butyrate-valerate, polyorthoester, polyethylene oxide-butylene terephthalate, poly-D,L-lactic acid-p-dioxanone-polyethylene glycol block copolymer, or a combination comprising at least one of the foregoing organic polymers.

27. The method of claim 19, where the polymer is a thermosetting polymer selected from the group consisting of epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or a combination comprising at least one of the foregoing thermosetting polymers.

28. The method of claim 26, where the polyolefin is linear low density polyethylene, low density polyethylene, or high density polyethylene.

29. The method of claim 26, where the polyolefin is low density polyethylene.

30. The method of claim 18, where the fluid is selected from the group consisting of [Cd(H₂N—(CH₂)₂—NH₂)₃](OH)₂, [Cd(NH₂—CH₂—CH₂)₃ N](OH)₂, [Co(H₂N—(CH₂)₂—NH₂)₂](OH)₂, [Cu(H₂N—(CH₂)₃—NH₂)₂](OH)₂, [Cu(NH₃)₄](OH)₂, [Cu(H₂N—(CH₂)₂—NH₂)₂](OH)₂, [Ni(NH₃)₆](OH)₂, [Ni(H₂N—(CH₂)₂—NH₂)₃](OH)₂, [Ni(NH₂ CH₂CH₂)₃N](OH)₂, Pden—[Pd(H₂N—(CH₂)₂—NH₂](OH)₂, [Zn(H₂N—(CH₂)₂—NH₂)₂](OH)₂, Na₆[Fe(C₄H₃O₆)₃], trimethylbenzyl ammonium hydroxide, tetraethylammonium hydroxide, dimethyldibenzyl ammonium hydroxide, guanidinium hydroxide, sodium hydroxide, lithium hydroxide, or a combination comprising at least one of the foregoing non-derivatizing solvents.

31. The method of claim 18, where the fluid is selected from the group consisting of
n-alkylpyridinium halides, n-oxides of tertiary amines and alkylsulfoxides.

32. The method of claim 18, where the fluid is dimethylsulfoxide.

33. The method of claim 18, where the mixing is conducted in a twin screw extruder.

34. The method of claim 18, where the mixing is conducted in a single or multiple screw extruder, Buss kneader, Henschel, helicones, Ross mixer, Banbury, roll mills, molding machines, injection molding machines, vacuum forming machines, blow molding machine, or combinations comprising at least one of the foregoing machines.

35. The method of claim 19, where the reduced crystallinity cellulose used to replace an existing biopolymer in a commercial product.

36. A composition comprising:
a compatible blend of a reduced crystallinity cellulose and a polymer; where the reduced crystallinity cellulose has crystallinity in an amount of about 10 to about 90 weight percent based on a total amount of cellulose.

37. The composition of claim 36, where the polymer is a polyolefin.

38. The composition of claim 36, where the polyolefin is low density polyethylene.

39. The composition of claim 36, further comprising a proppant, the proppant being effective to promote solvation of the cellulose by a solvent.
